(19) United States
(12) Patent Application Publication
(10) Pub. No.: US 2021/0165787 A1
(43) Pub. Date: Jun. 3, 2021

(54) INFORMATION PROCESSING DEVICE, INFORMATION PROCESSING SYSTEM, METHOD OF PROCESSING INFORMATION, AND NON-TRANSITORY RECORDING MEDIUM

(71) Applicants: JUN KIMURA, TOKYO (JP); TAKANORI MOHRI, KANAGAWA (JP)

(72) Inventors: JUN KIMURA, TOKYO (JP); TAKANORI MOHRI, KANAGAWA (JP)

(73) Assignee: Ricoh Company, Ltd., Tokyo (JP)

(21) Appl. No.: 17/102,588

(22) Filed: Nov. 24, 2020

(30) Foreign Application Priority Data
Nov. 29, 2019 (JP) 2019-217397

(51) Int. Cl. G06F 16/242; G06F 16/25

(52) U.S. Cl. CPC G06F 16/2423; G06F 16/252

(57) ABSTRACT

An information processing device includes circuitry acquires, from a user terminal, input information corresponding to a user input, which is received at the user terminal. The circuitry further searches for response information that is associated with the input information. The circuitry further responds to the user terminal with a response message that is generated based on the response information, which is associated with the input information. The circuitry further acquires external environment information related to at least one of the user terminal and the information processing device. The circuitry changes, according to the external environment information, at least one of search and response.

### CROSS-REFERENCE TO RELATED APPLICATION

This patent application is based on and claims priority pursuant to 35 U.S.C. § 119(a) to Japanese Patent Application No. 2019-217397, filed on Nov. 29, 2019, in the Japan Patent Office, the entire disclosure of which is hereby incorporated by reference herein.

### BACKGROUND

### Technical Field

Embodiments of the present disclosure relate to an information processing device, an information processing system, a method of processing information, and a non-transitory computer-readable recording medium storing instructions for executing a method of processing information.

### Related Art

Conventionally, a device such as a computer performs pattern recognition on user inputs, such as texts, voice, or images, to recognize a pattern of texts, voice, or images input by a user through a network. Then, based on a result of the pattern recognition, the device such as a computer holds a conversation, or dialog, with the user, responds to questions from the user, or performs device control, for example. This known technique is referred to as a chatbot, or simply referred to as “bot”.

For example, in order to assist a user to edit a dialog scenario used by the chatbot, there is a known method that displays characters or figures, as information that indicates which branch at which fork is selected or the like in the dialog scenario. In editing such the dialog scenario that changes depending on a flow of a conversation, there is a known method of making information corresponding to options be collectively browsable.

### SUMMARY

An exemplary embodiment of the present disclosure includes an information processing device. The information processing device is connected to a user terminal that receives a user input. The information processing device includes. The circuitry acquires, from the user terminal, input information corresponding to the user input, which is received by the user terminal. The circuitry further searches for response information that is associated with the input information. The circuitry further responds to the user terminal with a response message that is generated based on the response information, which is associated with the input information. The circuitry further acquires external environment information related to at least one of the user terminal and the information processing device. The circuitry changes, according to the external environment information, at least one of search and response.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of an overall configuration of an information processing system according to one or more embodiments of the present disclosure;

FIG. 2 is a block diagram illustrating an example of a hardware configuration of a user terminal according to one or more embodiments of the present disclosure;

FIG. 3 is a block diagram illustrating an example of a hardware configuration of an administrator terminal according to one or more embodiments of the present disclosure;

FIG. 4 is a block diagram illustrating an example of a hardware configuration of a server according to one or more embodiments of the present disclosure;

FIG. 5A and FIG. 5B are diagrams illustrating an example of a flow of dialog based on scenario information according to one or more embodiments of the present disclosure;

FIG. 6 is a diagram illustrating an example of category information according to one or more embodiments of the present disclosure;

FIG. 7 is a diagram illustrating an example of question-answer information according to one or more embodiments of the present disclosure;

FIG. 8 is a diagram illustrating an example of inquiry history information according to one or more embodiments of the present disclosure;

FIG. 9A and FIG. 9B are diagrams illustrating an example of dialog history information according to one or more embodiments of the present disclosure;

FIG. 10 is a diagram illustrating an example of a functional configuration of an information processing system according to one or more embodiments of the present disclosure;

FIG. 11 is a sequence diagram illustrating an example of overall process according to one or more embodiments of the present disclosure;

FIG. 12 is a flowchart illustrating an example of a process of acquiring and/or changing external environment information according to one or more embodiments of the present disclosure;

FIG. 13 is a diagram illustrating an example of a registration screen according to one or more embodiments of the disclosure; and

FIG. 14 is a diagram illustrating another example of an overall configuration of a chatbot system according to one or more embodiments of the disclosure.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Overall Configuration

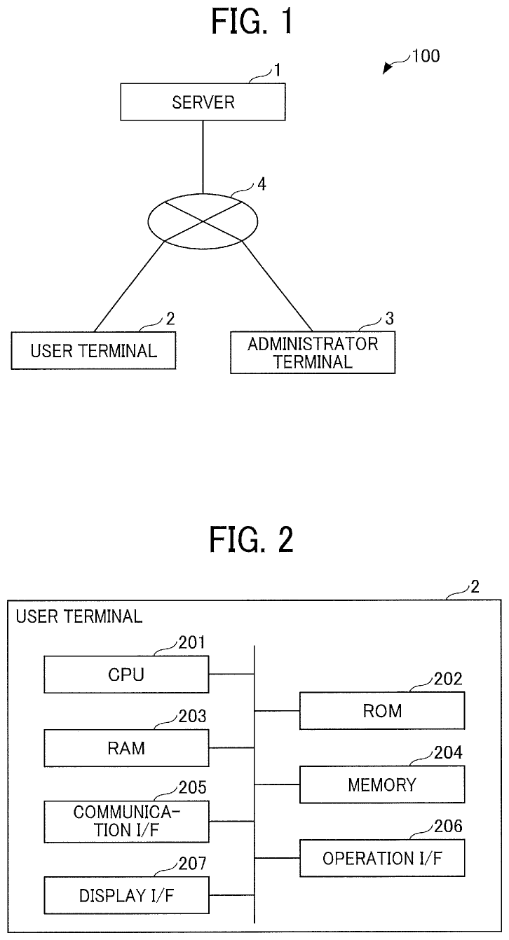

FIG. 1 is a block diagram illustrating an example of an overall configuration of an information processing system according to a first embodiment of the present disclosure. For example, a chatbot system 100 is an example of the information processing system and includes, for example, a server 1 and a user terminal 2. As illustrated in FIG. 1, the chatbot system 100 may include a device such as an administrator terminal 3 in addition to the server 1 and the user terminal 2.

The server 1 is an example of an information processing device that provides a chatbot service.

The user terminal 2 is an information processing device that is operated by a user for performing user operations such as inputting operations in the chatbot service. The number of the user terminals 2 being connected is not limited to one. In addition, the user terminal 2 may not be necessarily connected all the time.

The administrator terminal 3 is an information processing device operated by an administrator in order to manage the server 1, for example.

The server 1, the user terminal 2, and the administrator terminal 3 are connected to each other through a communication network 4, for example.

The communication network 4 is implemented by, for example, the Internet. The communication network 4 may be a communication network such as a local area network (LAN), a wide area network (WAN), a short-range communication, or a combination thereof, which performs wired or wireless communications.

The server 1 communicates with the user terminal 2 and the administrator terminal 3. For example, the server 1 provides a response message in order to respond to input information indicating a question that is input by a user, namely the server 1 provides the chatbot service.

The server 1 further provides a service that allows a plurality of users to exchange messages, so-called chat. Namely, the server 1 provides an instant message service. Note that various services may be provided by a plurality of information processing devices. In a description of the present embodiment (first embodiment) given below, the server 1, which provides such services is implemented by one information processing device.

In the chatbot service, when a user inputs characters or the like indicating a question or the like (hereinafter referred to as “input information”) to the user terminal 2, the server 1 acquires the input information from the user terminal 2 through the communication network 4. Then, the server 1 searches for information (hereinafter referred to as “response information”) that is to be an answer to the question, which is indicated by the input information. That is, the response information is associated with, or corresponding to, the input information. Then, the server 1 generates a response message based on the response information associated with the input information and responds to the user terminal 2 with the response message through the communication network 4. In this way, the user terminal 2 displays the response information associated with the input information as a message format for the user. In addition, the server 1 may perform predetermined processing on the response information associated with the input information to generate a response message to be provided to the user terminal 2 as a response (answer to the question), instead of providing the response information as it is. That is, the response message based on the response information is provided to the user terminal 2 as a response. As described above, the user uses the chatbot service and obtains an answer to the question.

A description is given below of a hardware configuration of a device and a data configuration of a database used to implement the chatbot service according to one or more embodiments of the disclosure.

User Terminal

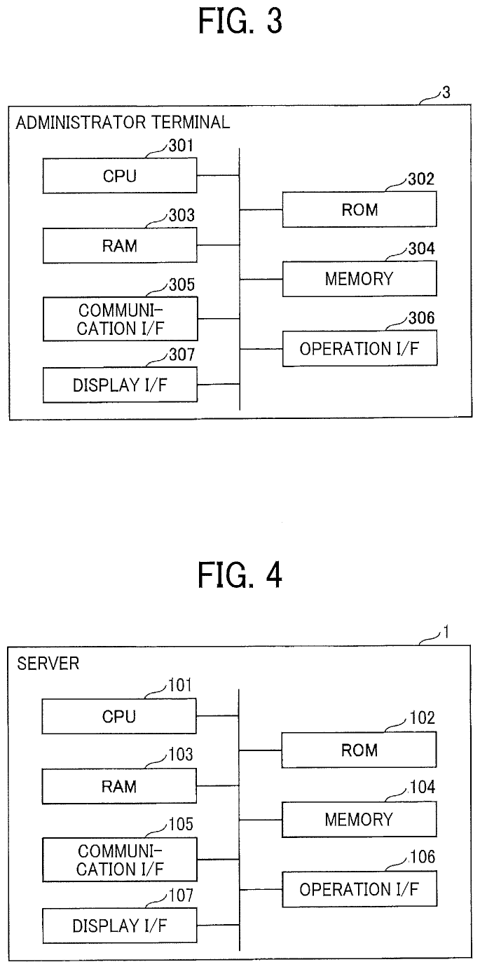

FIG. 2 is a block diagram illustrating an example of a hardware configuration of the user terminal 2 according to one or more embodiments of the present disclosure. For example, the user terminal 2 includes a central processing unit (CPU) 201, a read only memory (ROM) 202, a random access memory (RAM) 203, a memory 204, a communication interface (I/F) 205, an operation I/F 206, and a display 207. The above-mentioned hardware components included in the user terminal 2 are connected to each other by a bus, for example. Each hardware component of the user terminal 2 may be connected to another device by wired or wireless communications.

The user terminal 2 is, for example, an information processing device such as a personal computer (PC), a smartphone, or a tablet.

The CPU 201 implements the functions of an operation unit and a control unit, for example. The CPU 201 is an example of a control device and an operation device.

The ROM 202 is a non-volatile storage device, for example.

The RAM 203 is a volatile storage device, for example.

The memory 204 is an example of a main storage device. For example, the memory 204 stores information acquired through the communication network 4. The user terminal 2 may further include an auxiliary storage device such as a hard disk or a solid state drive (SSD). The ROM 202, the RAM 203, or the memory 204 implements the functions of a storage unit.

The communication I/F 205 implements the functions of a communication unit. For example, the communication I/F 205 is a connection terminal, a communication circuit, or the like.

The operation I/F 206 implements the functions of an input unit. For example, the operation I/F 206 is an input device such as a button, a keyboard, a dial, a key, a touch panel, or a microphone.

The display 207 implements the functions of an output unit. For example, the display 207 is an output device such as a liquid crystal panel, an organic electroluminescence (EL), or an inorganic EL. The display 207 and the operation I/F 206 may be configured as one hardware component such as a touch panel.

One or more programs may be stored in, for example, an auxiliary storage device in addition to or in alternative to the ROM 202 or the memory 204. One or more programs may be acquired through a network, for example.

Administrator Terminal

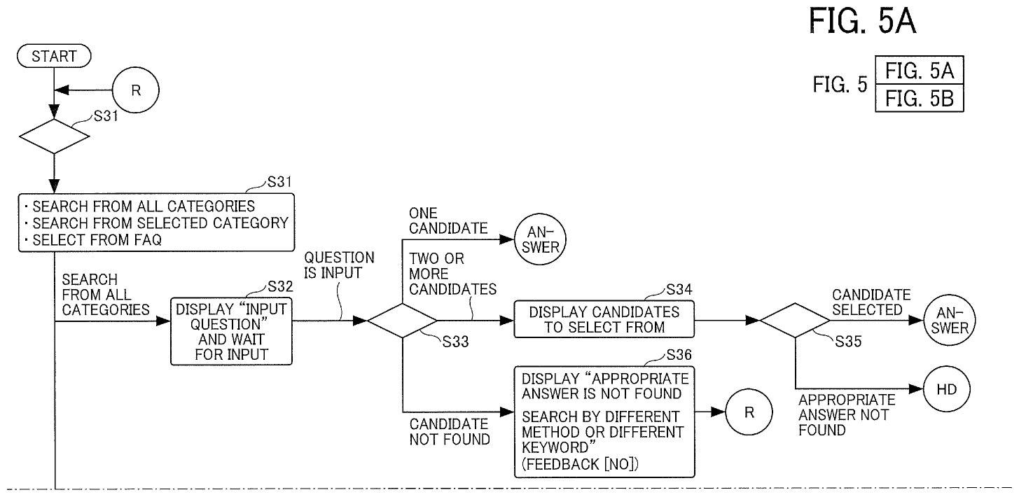

FIG. 3 is a block diagram illustrating an example of a hardware configuration of the administrator terminal 3 according to one or more embodiments of the disclosure. For example, the administrator terminal 3 includes a CPU 301, a ROM 302, a RAM 303, a memory 304, a communication I/F 305, an operation I/F 306, and a display 307. In the following description of the present embodiment, the administrator terminal 3 has the same hardware configuration as the user terminal 2, and redundant description is omitted. In some embodiments, the administrator terminal 3 may have a hardware configuration different from the user terminal 2 or the server 1.

Server

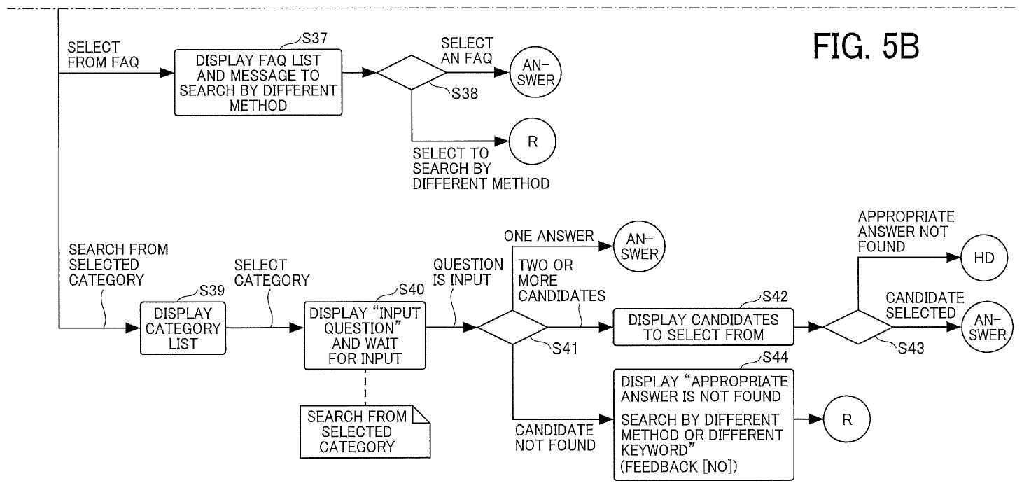

FIG. 4 is a block diagram illustrating an example of a hardware configuration of the server 1 according to one or more embodiments of the present disclosure. For example, the server 1 includes a CPU 101, a ROM 102, a RAM 103, a memory 104, a communication I/F 105, an operation I/F 106, and a display 107. In the following description of the present embodiment, the server 1 has the same hardware configuration as the user terminal 2, and redundant description is omitted. In some embodiments, the server 1 may have a hardware configuration different from the user terminal 2 or the administrator terminal 3.

Database (DB)

The server 1 has databases (DBs) as described below preliminary to using the chatbot service in the chatbot system 100, for example. In the present embodiment described below, the server 1 has a keyword DB, a synonym DB, a dialog scenario DB, a category DB, a question-answer DB, an inquiry history DB, a dialog history DB, and a contract information DB.

The keyword DB stores character strings indicating characteristics of questions and answers, namely, keywords. The keywords may be words, phrases or sentences. In addition, the keyword DB may store keywords not related to question-answer information.

For example, at first, the server 1 decomposes a character string of a question into words. Next, the server 1 collates each decomposed word with words stored in the keyword DB and searches for a keyword of the question. Then, the server 1 searches the character strings of “question” in the question-answer information DB for a word that matches the keyword to detect question-answer information corresponding to the question. As described above, the keyword DB is used to extract a keyword indicated by a question.

The synonym DB stores synonym information corresponding to the keywords or the like. For example, the synonym information is information that associates character strings having similar meanings with each other. Each character string may be a word, a phrase, or a sentence. Further, the character strings having similar meanings are not limited to the character strings having similar meanings. For example, character strings that have similar meanings to each other may be a character string that can deduce the other from one, or one may be a character string that is a part of the other. In addition, for example, character strings that have similar meanings to each other may be character strings that are used in similar situations. In addition, the synonym information may be arbitrary defined according to a usage environment.

At first, the server 1 decomposes a character string of a question that is indicated by input information into words. Next, the server 1 collates each word with the synonym DB and extracts a character string that is determined as a synonym. As described above, the server 1 collates the words included in the question and the synonyms corresponding to the words with the keyword DB to obtain one or more keywords of the question.

The dialog scenario DB stores scenario information for achieving a dialog according to input information. For example, the scenario information is generated so that a dialog is to be held with a user according to a scenario input in advance in the dialog scenario DB.

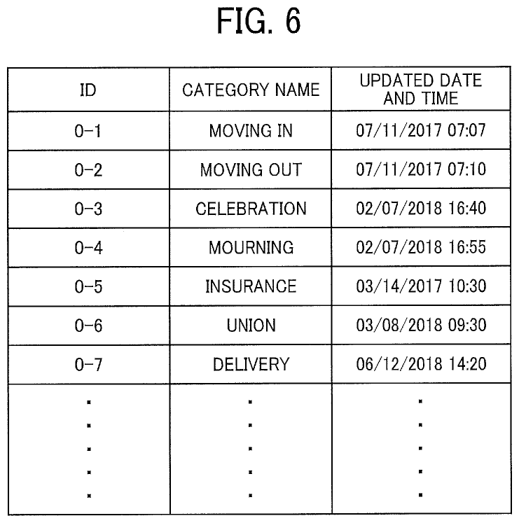

FIG. 5A and FIG. 5B are diagrams illustrating an example of a flow of a dialog based on scenario information according to one or more embodiments of the present disclosure. An example of such a flow in which the input information corresponding to a question is received from a user and the response information corresponding to an answer to the received question is output based on the scenario information is described below.

Example of Dialogue Flow Based on Scenario Information

For example, the scenario information is input in the chatbot system in advance by an administrator so as to follow the flow illustrated in FIG. 5A and FIG. 5B. Then, the chatbot system conducts a dialog with the user based on the scenario information. Specifically, the chatbot system is set with the scenario information, a database, a Graphical User Interface (GUI), and the like in advance to achieve to have communication with the user according to the flow as illustrated in FIG. 5A and FIG. 5B. A detailed description of the flow is given below.

In step S31, at first, the chatbot system causes the user terminal 2 to display a selection menu for selecting a question search method. For example, the selection menu includes three options such as “search from all categories”, “Search from a selected category”, and “Search from frequently asked questions (FAQ)”. The selection menu is an example of the GUI that receives a user operation, in which the user selects one of the above-mentioned three options. Alternatively, the selection menu may display four or more options or two or less options in some embodiments.

When “Search from all categories” is selected from the selection menu (“SEARCH FROM ALL CATEGORIES” in FIG. 5A), the process of the chatbot system proceeds to step S32. In addition, when “Search from frequently asked questions” is selected from the selection menu (“SELECT FROM FAQ” in FIG. 5A), the process of the chatbot system proceeds to step S37. In addition, when “select from a selected category” (“SELECT FROM SELECTED CATEGORY” in FIG. 5A) is selected from the selection menu, the process of the chatbot system proceeds to step S39.

In step S32, the chatbot system causes the user terminal 2 to display a message that prompts the user to input characters, or texts, namely a character string corresponding to a question. Further, the chatbot system causes the user terminal 2 to display a GUI such as a text box to which the user input the characters, or the texts, namely the character string corresponding to the question. Next, when the question is input (“INPUT QUESTION” in FIG. 5A), the process of the chatbot system proceeds to step S33.

In step S33, the chatbot system analyzes the character string indicating the question. Then, the chatbot system searches the question-answer DB and extracts a candidate that may be an answer to the question (hereinafter, simply referred to as “candidate”). The chatbot system may acquire two or more candidates as a result of the search.

As a result of the search in step S33, when there is one candidate found (“ONE CANDIDATE” in FIG. 5A), the chatbot system responds with response information corresponding to the found candidate as the result of the search. When the result of the search in step S33 indicates that there are two or more candidates found (“TWO OR MORE CANDIDATES” in FIG. 5A), the process of the chatbot system proceeds to step S34. In addition, the result of the search in step S33 indicates that there is no candidate detected (“CANDIDATE NOT FOUND” in FIG. 5A), the process of the chatbot system proceeds to step S36.

In step S34, the chatbot system causes the user terminal 2 to display a GUI that allows the user to perform one of operations of selecting one of the plurality of candidates and deselecting all the candidates.

In step S35, when the operation of selecting one of the plurality of candidates is performed (“CANDIDATE SELECTED” in FIG. 5A), the chatbot system responds with the response information corresponding to the selected candidate. On the other hand, when no candidate is selected (“APPROPRIATE CANDIDATE NOT FOUND” in FIG. 5A), the chatbot system causes the user terminal 2 to display a message indicating an apology for that the answer is not being displayed. The message indicates that the answer to the question is not found at the current step, for example.

In step S36, the chatbot system causes the user terminal 2 to display a message indicating the apology and a message prompting the user to search again, and then the process returns to step S31.

In step S37, the chatbot system refers to the inquiry history DB and extracts one or more frequently inquired questions (for example, three questions), which are previously asked from other users. Then, the chatbot system causes the user terminal 2 to display a list of the questions, namely an FAQ list. Further, the chatbot system causes the user terminal 2 to display a GUI for selecting another search method.

In step S38, when a question is selected (“FAQ SELECTED” in FIG. 5B), the chatbot system responds with an answer to the selected question obtained by searching the question-answer DB, as the response information. On the other hand, when another search method (different method) is selected in step S38 (“SELECT TO SEARCH BY DIFFERENT METHOD” in FIG. 5B), the process of the chatbot system returns to step S31.

In step S39, the chatbot system causes the user terminal 2 to display a list of category names, namely a category list. Then, when an operation of selecting a category from the list of category names is performed (“SELECT CATEGORY” in FIG. 5B), the process of the chatbot system proceeds to step S40.

In step S40, the chatbot system receives a user operation of inputting characters corresponding to a question. Next, when the question is input (“INPUT QUESTION” in FIG. 5B), the chatbot system acquires the input information indicating the question. Then, the process of the chatbot system proceeds to step S41.

In step S41, the chatbot system searches the question-answer DB and extracts candidates. When there is one candidate found (“ONE CANDIDATE” in FIG. 5B), the chatbot system responds with the response information corresponding to the found candidate as the result of the search. When there are two or more candidates found (“TWO OR MORE CANDIDATES” in FIG. 5B), the process of the chatbot system proceeds to step S42. In addition, when there is no candidate detected (“CANDIDATE NOT FOUND” in FIG. 5B), the process of the chatbot system proceeds to step S44.

In step S42, the chatbot system causes the user terminal 2 to display a GUI that allows the user to perform one of operations of selecting one of the plurality of candidates and deselecting all the candidates.

In step S43, when the operation of selecting one of the plurality of candidates is performed (“CANDIDATE SELECTED” in FIG. 5B), the chatbot system responds with the response information corresponding to the selected candidate. On the other hand, when no candidate is selected (“APPROPRIATE CANDIDATE NOT FOUND” in FIG. 5A), the chatbot system causes the user terminal 2 to display a message indicating an apology for that the answer is not being displayed. The message indicates that the answer to the question is not found at the current step, for example.

In step S44, the chatbot system causes the user terminal 2 to display a message indicating the apology and a message prompting the user to search again, and then the process returns to step S31.

The scenario information expecting the above-described dialog flow is input, for example. That is, the scenario information indicates a result set by the administrator, which includes a type of each GUI and an order of outputting messages or GUIs used in the flow of the dialog, for example.

The category DB stores category information for classifying questions. A description of an example of the category information is given below.

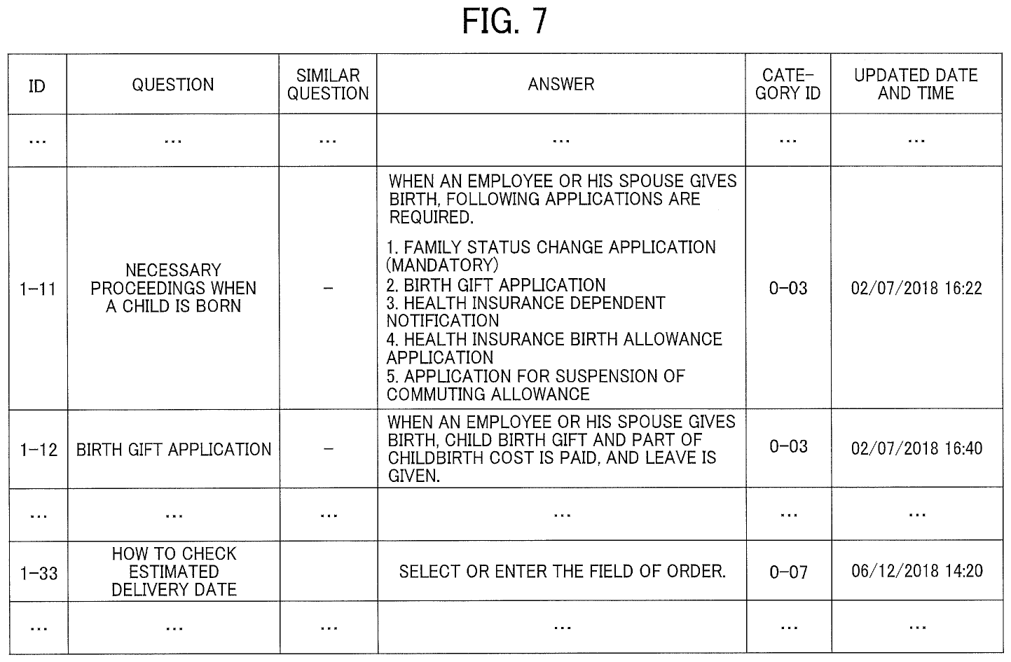

FIG. 6 is a diagram illustrating an example of category information according to one or more embodiments of the present disclosure. For example, as illustrated in FIG. 6, the category information includes items of “ID”, “CATEGORY NAME”, and “UPDATED DATE AND TIME”.

A data item of “CATEGORY NAME” indicates a category with which a question is associated.

A data item of “ID” indicates an ID (Identification), that is, identification information of each category.

A data item of “UPDATED DATE AND TIME” indicates a date and time when associated information (record) is updated.

The question-answer DB stores information including a question and an answer associated with each other (hereinafter referred to as “question-answer information”). For example, the question-answer information is generated in advance by the administrator and stored in the question-answer DB. A description of an example of the question-answer information is given below.

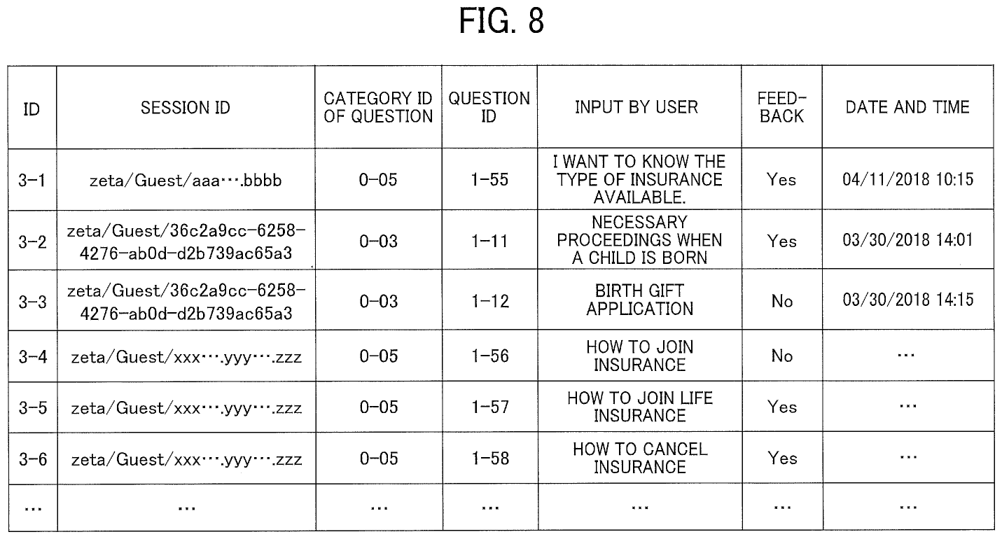

FIG. 7 is a diagram illustrating an example of question-answer information according to one or more embodiments of the present disclosure. For example, as illustrated in FIG. 7, the question-answer information includes items of “ID”, “QUESTION”, “SIMILAR QUESTION”, “ANSWER”, “CATEGORY ID”, and “UPDATED DATE AND TIME”.

A data item of “ID” indicates an ID (Identification), that is, identification information of a record of the question-answer information.

A data item of “QUESTION” indicates content of a question.

A data item of “SIMILAR QUESTION” indicates a question having content similar to the question input as a data item of a “QUESTION”.

A data item of “ANSWER” indicates an answer to the question, which is in the same record.

A data item of “CATEGORY ID” indicates an ID for a category corresponding to the question.

A data item of “UPDATED DATE AND TIME” indicates a date and time when associated information (record) is updated.

The inquiry history DB stores information indicating one or more questions previously input by users (hereinafter referred to as “inquiry history information”). A description of an example of the inquiry history information is given below.

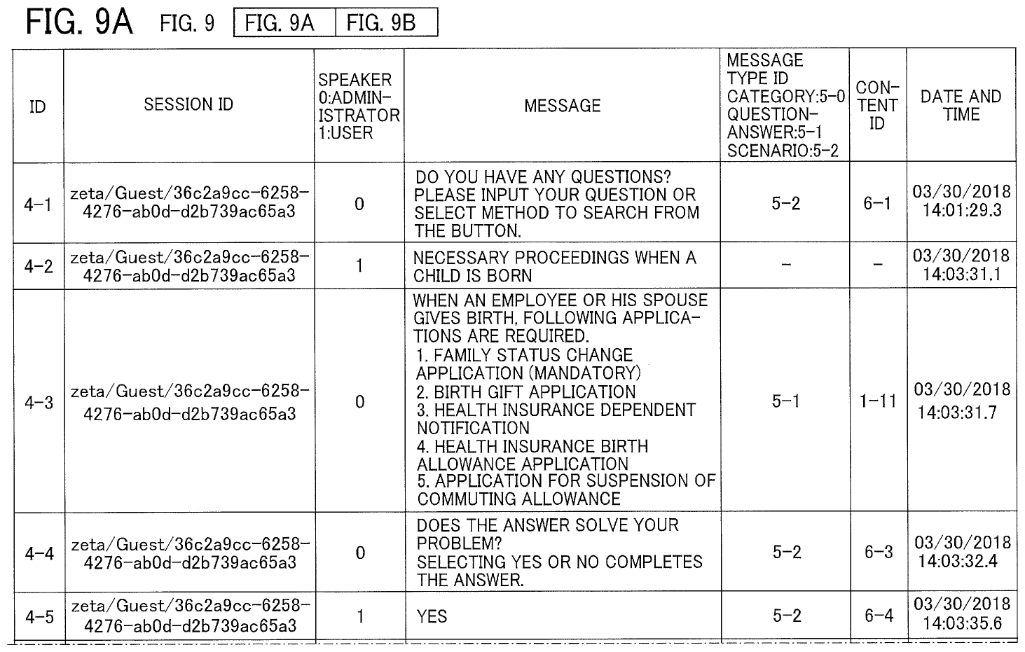

FIG. 8 is a diagram illustrating an example of inquiry history information according to one or more embodiments of the present disclosure. As illustrated in FIG. 8, the inquiry history information includes items of “ID”, “SESSION ID”, “CATEGORY ID OF QUESTION”, “QUESTION ID”, “INPUT BY USER”, “FEEDBACK”, AND “DATE AND TIME”.

A data item of “ID” indicates an ID, that is, identification information of a record of the inquiry history information.

A data item of “SESSION ID” indicates identification information for identifying a dialogue session in which a question is asked.

A data item of “CATEGORY ID OF QUESTION” indicates a category ID for identifying a category with which a question, which is hit, is associated.

A data item of “QUESTION ID” is an ID for identifying a question.

A data item of “INPUT BY USER” indicates a user input that is a question input by a user.

A data item of “FEEDBACK” indicates whether a user has given feedback to an answer to a question.

A data item of “DATE AND TIME” indicates a date and time when a dialog is hold.

A dialog session indicates a dialog performed between the user terminal 2 and the server 1. For example, a dialog included in the same dialog session is a dialog performed with the user terminal 2 from a time at which a screen used for the dialog in a chat format is opened to a time at which the screen is closed, or a dialog performed from a time at which the screen is launched to a time at which the screen is forced to be closed due to a session timeout.

The session timeout occurs when there is no action being taken with respect to the user terminal 2 within a certain time that is set in advance. The session timeout is a process of ending the screen or the like used for the dialog.

The dialog session is not limited to the above-described examples. For example, the dialogue session may be a dialog that is from an input of a question to an input of feedback performed by a user after the user receives a response to the input question. In such a case, the dialogue session ends when the feedback is obtained from the user.

The dialogue history DB stores information (hereinafter referred to as “dialogue history information”) indicating a history including content of inputs to the user terminal 2 and content outputs from the server 1 in a dialogue performed between the user terminal 2 and the server 1. A description of an example of the dialog history information is given below.

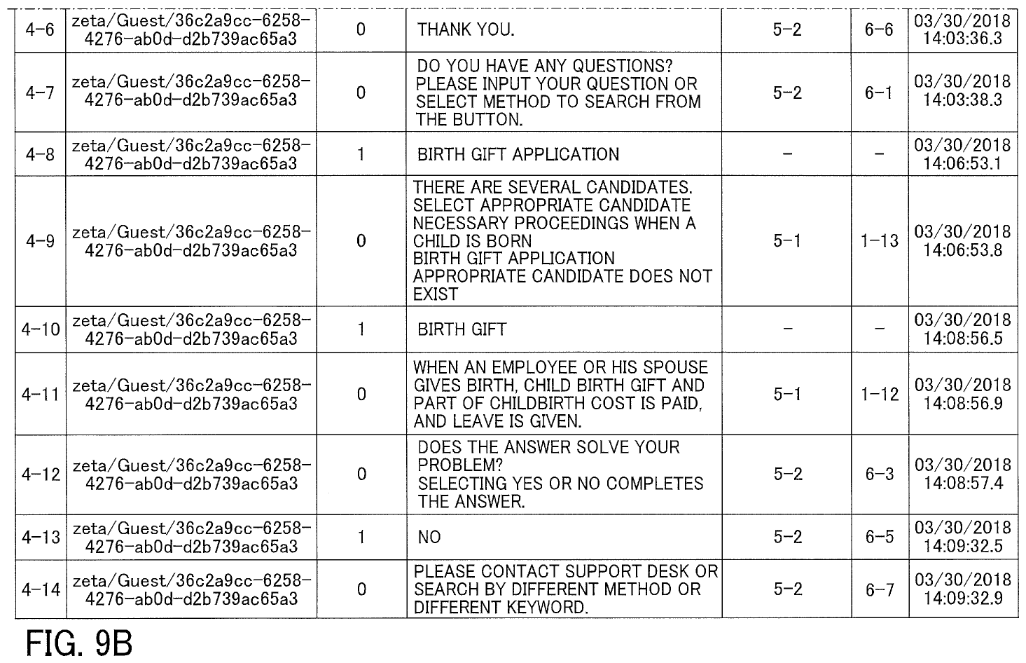

FIG. 9, which includes FIG. 9A and FIG. 9B, is a diagram illustrating an example of dialog history information according to one or more embodiments of the present disclosure. As illustrated in FIG. 9, which includes FIG. 9A and FIG. 9B, the dialogue history information includes items of “ID”, “SESSION ID”, “SPEAKER”, “MESSAGE”, “MESSAGE TYPE ID”, “CONTENT ID”, and “DATE AND TIME”.

A data item of “ID” indicates an ID, that is, identification information of a record of the dialog history information.

A data item of “SESSION ID” indicates an ID for identifying a dialogue session.

A data item of “SPEAKER” indicates a type of a user (person) who inputs words, or a message, as apart of a dialog. Specifically, “0” or “1” is input as a data item of “SPEAKER”. “0” indicates that a message is made by an administrator. On the other hand, “1” indicates that a message is made by a general user, namely a user.

A data item of “MESSAGE” indicates content of input words as a part of dialog.

Regarding “MESSAGE TYPE ID”, for example, “5-0”, “5-1”, or “5-2” is input.

Based on the inputs mentioned above, “MESSAGE TYPE ID” indicates which one of “CATEGORY”, “QUESTION-ANSWER INFORMATION”, and “SCENARIO” is used for a corresponding data item of “MESSAGE”.

When a message type is “SCENARIO”, a data item of “content ID” indicates an ID identifying a message set in a scenario. When a message type is “QUESTION-ANSWER INFORMATION”, a data item of “content ID” indicates an ID identifying the question-answer information. When a message type is “CATEGORY”, a data item of “content ID” indicates an ID identifying the category.

A data item of “DATE AND TIME” indicates a date and time when a dialog is hold.

The contract information DB stores contents of a contract concluded with a user in advance. For example, information such as whether or not to perform manned support and a period for which the support is provided is input to the contract in advance. In addition, the server 1 may hold acquired contract information in association with a contractor ID, for example.

The type and the configuration of each DB are not limited to the above-described example. That is, each DB may have another format. In addition, each DB may be configured as data that is held in a distributed manner among a plurality of devices. Furthermore, in some embodiments, each DB described above is not necessarily included in the DBs. That is, a format of each DB or the like is not a matter as long as a scenario is implementable by the data.

Functional Configuration

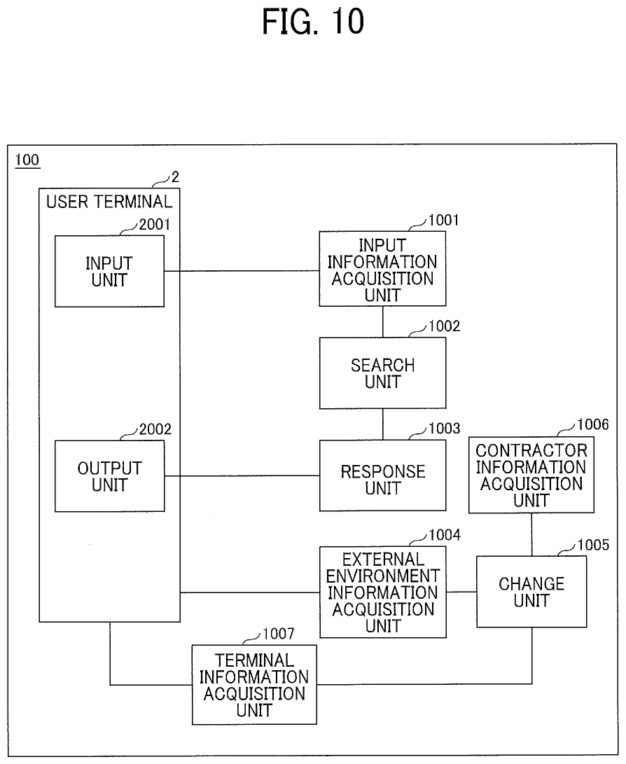

FIG. 10 is a block diagram illustrating an example of a functional configuration of a chatbot system (information processing system) according to one or more embodiments of the disclosure. The chatbot system 100 includes, for example, an input information acquisition unit 1001, a search unit 1002, a response unit 1003, an external environment information acquisition unit 1004, and a change unit 1005.

The input information acquisition unit 1001 acquires input information that is input to the user terminal 2.

The search unit 1002 searches for response information associated with the input information.

The response unit 1003 responds to the user terminal 2 with the response information that is a response to the input information.

By the input information acquisition unit 1001, the search unit 1002, and the response unit 1003, the response information associated with the input information, which is input via the input unit 2001, is output via the output unit 2002, and thereby resulting in establishment of a dialog, namely, implementation of a bot.

For example, the input information acquisition unit 1001 is implemented by, for example, the communication I/F 105 and acquires the input information from the user terminal 2. The search unit 1002 is implemented by, for example, the CPU 101 and searches for the response information associated with the input information. The response unit 1003 is implemented by, for example, the communication IF 105 and responds with the response information.

The external environment information acquisition unit 1004 acquires external environment information related to the user terminal 2 or the server 1. For example, the external environment information acquisition unit 1004 is implemented by the communication I/F 105 and acquires the external environment information related to the user terminal 2 or the server 1.

The change unit 1005 changes search performed by the search unit 1002 or response performed by the response unit 1003 based on the external environment information. For example, the change unit 1005 is implemented by the CPU 101 and changes the search or the response.

In addition, the chatbot system 100 may have a functional configuration including a contractor information acquisition unit 1006 or a terminal information acquisition unit 1007.

The contractor information acquisition unit 1006 is implemented by, for example, the communication I/F 105 and acquires location information of the server 1. Hereinafter, position information is replaceable with the location information. The information acquired by the contractor information acquisition unit 1006 is not limited to the information on the server 1, but also registration information indicating a location of a place related to a contractor, for example.

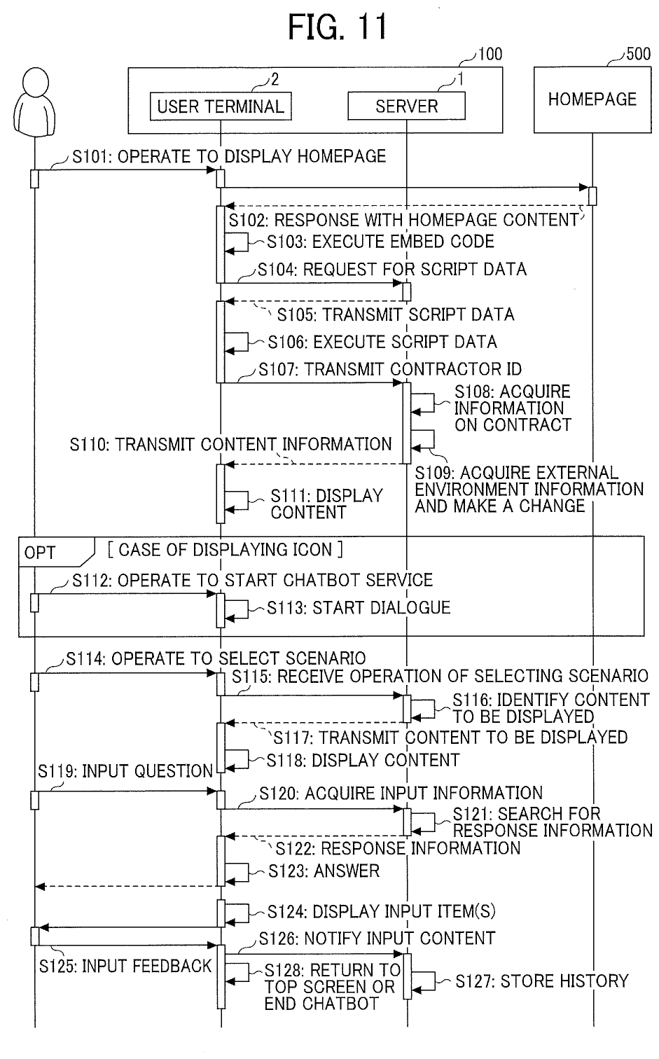

The terminal information acquisition unit 1007 is implemented by, for example, the communication I/F 105, and acquires terminal information such as an internet protocol (IP) address or global positioning system (GPS) information from a terminal, such as the user terminal 2. The terminal information is transmitted from the user terminal 2 to the server 1 at any timing of step S104, step S107, step S112, step S115, or step S120, which is illustrated in FIG. 11. For example, in step S120, the input information acquisition unit 1001 acquires the input information, and the terminal information acquisition unit 1007 acquires the terminal information.

In addition, the server 1 may further include functions such as a calculation unit (an operation unit) and/or a control unit that are/is implemented by the CPU 101 and/or the like. In addition, the server 1 may further include functions such as an input unit, an output unit, a storage unit, and/or a communication unit. In addition, the user terminal 2 may further include functions such as a calculation unit (an operation unit), a control unit, a storage unit, an input unit, an output unit, and/or a communication unit.

Example of Overall Process

FIG. 11 is a sequence diagram illustrating an example of an overall process according to one or more embodiments of the present disclosure. A description of the present embodiment in which the server 1 independently performs the process for implementing the chatbot service is given below.

In step S101, the input unit 2001 of the user terminal 2 receives an operation to activate a chatbot, namely receives a chatbot activation request. For example, the input unit 2001 of the user terminal 2 receives an operation of pressing a certain icon included in a web page displayed, an operation to start an interactive application (interactive dialog application) installed on the user terminal 2, or an operation of pressing a certain button of the interactive application.

In step S102, a homepage 500 responds to the chatbot activation request, which is from the user terminal 2. Specifically, in the homepage 500, an embed code is embedded in a source code of the homepage 500 in advance. In step S102, the user terminal 2 is in a state of being capable of performing a process based on the embed code.

In step S103, the operation unit of the user terminal 2 executes the embed code.

In step S104, based on the embed code, the communication unit of the user terminal 2 requests script data generated by, for example, JavaScript (registered trademark).

In step S105, the communication unit of the server 1 transmits the script data, which is requested in step S104, to the user terminal 2.

In step S106, the operation unit of the user terminal 2 executes the script data.

In step S107, the communication unit of the user terminal 2 transmits to the server 1 a content request that is a request for content of the chatbot and a contractor (tenant) ID that identifies a contractor (tenant) of the chatbot.

The contractor ID is information held in advance by the user terminal 2. The contractor ID may be held by a browser used for the chatbot. Alternatively, the contractor ID may be held by an application that implements a chat function.

In step S108, the operation unit of the server 1 acquires information on a contract corresponding to the contractor ID from the contract information DB. Then, the operation unit of the server 1 determines a status of the contract based on the contractor ID. In the following description, an example case, in which the contract indicates that the status of the chatbot service is available, is given.

In step S109, the server 1 acquires external environment information as described below, for example, and the server 1 further makes a change as described below, for example.

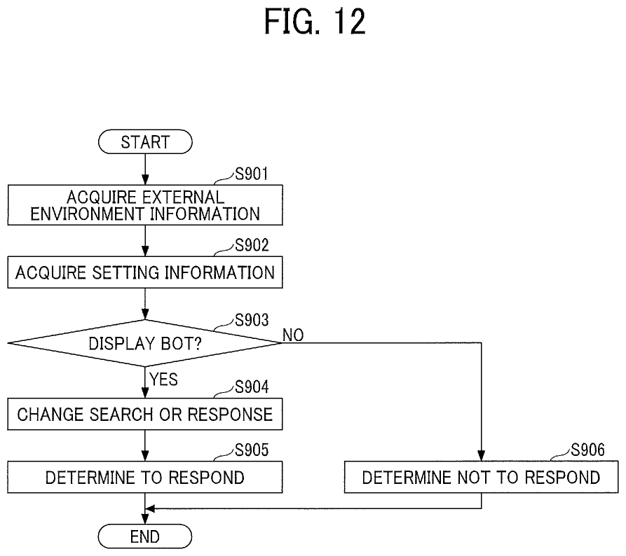

FIG. 12 is a flowchart illustrating an example of a process of acquiring the external environment information and making a change according to one or more embodiments of the present disclosure. In some embodiments, the process as illustrated in FIG. 12 may be performed at a timing other than step S109. For example, the process as illustrated in FIG. 12 may be performed each time when a page accessed by the user terminal 2 changes or a request for the bot is received.

In step S901, the external environment information acquisition unit 1004 acquires the external environment information of the user terminal 2 or the server 1.

Example of Acquisition of External Environment Information

The external environment information is information indicating environment of a location where the user terminal 2 or server 1 is placed or environment of a surrounding area of the user terminal 2 or the server 1. Specifically, the external environment information is information on time (time information), information on weather (weather information), information on season (season information), information on traffic or transportation (traffic information), information on network status (network status information), information on location (location information), or any combination of two or more of these information, for example.

The information on time indicates a time at the location where the user terminal 2 or the server 1 is placed.

Specifically, when the location where the user terminal 2 or the server 1 is placed is identified, time applied to the location or the area is identified. That is, for example, when the user terminal 2 is located in Japan, the so-called Japan Standard Time is acquired from an external device. In some embodiments, the time to be acquired may not strictly indicate an exact time that includes seconds, that is, the time may be indicated excluding seconds. In addition, in some embodiments, the time to be acquired may be a classified time that is roughly classified as “morning”, “daytime”, or “night”, for example.

The information on weather indicates meteorological information that includes information on weather, temperature, rainfall, humidity, dryness, disaster, or forecasts of these (including long-term forecasts forecasting one week or more ahead) in the location or area in which the user terminal 2 or the server 1 is placed.

Specifically, when the location where the user terminal 2 or the server 1 is placed is identified, the meteorological information, which is measured or forecasted in the location or the area, or weather warning, which is issued in the location or the area, is also identified. That is, when the area where the user terminal 2 is located is identified, the meteorological information corresponding to the area is obtainable from an external device (for example, a server of the Japan Meteorological Agency or a server of a local government) that provides weather data. In some embodiments, the user terminal 2 or the server 1 may include a sensor such as a thermometer, and the weather may be specified based on a measurement result obtained by the sensor.

The information on season indicates a season of the four seasons in the location or the area where the user terminal 2 or the server 1 is placed. For example, according to information obtained, such as information on a date, the season is specified as one of “spring”, “summer”, “autumn”, and “winter”.

The information on traffic or transportation is information indicating whether transportation or the like in the location or the surrounding area where the user terminal 2 or the server 1 is placed, is normally operating. For example, such information indicates operation statuses of railways, traffic conditions on roads, conditions of an airport, or marine traffic conditions in the location or the surrounding area where the user terminal 2 or the server 1 is placed. Hereinafter, the information on traffic or transportation may be simply referred to as traffic information.

Specifically, when the location where the user terminal 2 is placed is identified, information indicating whether a transportation to be used for moving to another place from the current location or surrounding area of the user is available or not is obtainable. An example of the other place, which is a destination from the current location or surrounding area, includes a work site such as an office of the user, and the location of the work site is same as the location of the server 1. In addition, the information indicates not only whether the transportation is currently available, but also may include an operation schedule of the transportation, for example. When the destination (such as a work site) is identified, the traffic information may include information targeting a transportation network on a route from the current location of the user to the destination. For example, traffic information is acquired from a server of a railway company or the like based on location information of the user terminal 2 or the server 1.

The network status is information indicating whether a network is available, or whether an information processing device that is used through a network is available. For example, there is a case in which the user terminal 2 may not be able to access a predetermined server due to a network failure or a hardware failure. The network status is information indicating a result obtained by checking whether such the above-mentioned case occurs. For example, by using a so-called “ping” command, whether a predetermined server is available through a network or not is determinable. In addition, information used to acquire the network status (for example, the IP address of a target server) is set in advance.

The position information (location information) is information indicating a position (location) of the user terminal 2 or the server 1. For example, the position information is acquired by Global Positioning System (GPS). The position information may be information that is estimated based on other information. The position information is information that identifies a current position or a predetermined position of a user.

In step S902, the change unit 1005 acquires setting information.

The setting information is, for example, information indicating what type of change it to be made. The setting information is set by the administrator in advance, for example. Accordingly, based on the setting information, a scenario, an FAQ (FAQ list), a database or the like is changed.

In the following description, an example case in which a bot is installed on a homepage of a company, and the bot is installed so as to be mainly used by employees (hereinafter may be referred to as a “worker”) employed by the company.

In this example, for example, when a disaster such as heavy rain occurs, the number of questions from users, or employees, related to whether to go to a work site increases.

Then, in subsequent processing, when a determination indicates, based on the external environment information, that the transportation is not available, the response unit 1003 may respond with the response information such as a message, “You do not need to go to work today.” To implement this, criteria used for determining whether current weather is good enough for a worker to go work and a server for acquiring the traffic information used for determining whether a transportation is available or not, are set in the setting information, for example.

In a case in which a disaster does not occur, when a question inquiring about whether an employee is required to go to a work site is input as the input information, the response unit 1003 responds, based on the external environment information, with a message such as “You need to go to work today.”, for example. On the other hand, in a case in which a disaster occurs, when a question inquiring about whether an employee is required to go to a work site is input as the input information, the response unit 1003 responds, based on the external environment information, with a message such as “You do not need to go to work today.”, for example. As described above, the response by the response unit 1003 may change based on the external environment information. That is, the response dynamically changes according to changes in the external environment.

When such a change is made, for example, the number of operations performed by the administrator to manually change the response reduces. This reduces the number of man-hours of the administrator for managing the bot, for example.

The change unit 1005 is not limited to change the response. For example, the scenario, the FAQ (FAQ list), or the database may be switched, or changed. For example, the change unit 1005 changes the scenario according to an occurrence of a disaster so that the “frequently asked questions” includes more questions related to a disaster compared with other scenarios used when there is no disaster. This allows the users to make an inquiry about a disaster quickly. In some embodiments, the change unit 1005 may change the settings so as to narrow down the database to be related to disasters for search.

In some embodiments, the change unit 1005 may change a display order based on the external environment information. For example, the change unit 1005 changes, according to an occurrence of a disaster, the display order or a user interface (UI) in a manner that a top screen of the bot is capable of receiving an input for a question that is often asked when such a disaster occurs. In addition, questions, such as questions related to a disaster manual, that are not often asked when disaster does not occur may increases when a disaster occurs. Such the questions may be displayed in an order different from when a disaster does not occur so that such the questions are obtainable quickly by the user.

As described above, making a change in the search or the response according to the external environment allows the user to check the information, which the user desires to know, faster than usual case. This improves user satisfaction.

In addition, changes as described below may be performed.

In the following description, it is assumed that the bot is installed on a homepage of a company and used to deal with inquiries about one or more products introduced on the homepage of the company. In such an example in the following description, the user is a person (purchaser, consumer, customers) who has purchased or is considering purchasing the product(s).

Which product the company desires to recommend to the user, or the purchaser (consumer, customers), may change depending on weather, season, or time in a day. That is, some companies deal with products, so-called seasonal products, whose demand changes significantly depending on the season. In such a case, when a user asks a question regarding a recommended product, a product that is suitable for a current season may be recommended among the products.

Accordingly, the setting information in this case may include information that associates the weather, the season, or the time with the product, for example. With such the setting information, the response unit 1003 may change a recommended product as a response (answer) to the question, based on the external environment information and according to the season.

In addition, such a change may be made depending on the position information of the user or an area, in particular a specific area, input by the user. Some companies may carry out different corporate activities in each region, such as selling products in a limited region, holding an event in a limited region, or selling products with different specifications or prices in each region. Accordingly, when a user inquiries about an event, a product specification, or a price, the search or the response may be performed, in response to such an inquiry, in consideration of the region based on the position information, for example.

To deal with this, for example, in the subsequent search, the change unit 1005 may narrow down the information to be information corresponding to the area specified based on the position information for the search, which results in that the information on the other areas is not used as the response.

As described above, making a change in the search or the response according to the external environment allows the user to quickly check the information appropriate for the user. This improves user satisfaction.

In addition, changes as described below may be performed.

In the following description, it is assumed that the bot is installed on a homepage of a company and operated by a server that is different from a server of the homepage introducing one or more products of the company. In such an example in the following description, the user is a person (purchaser, consumer, customers) who has purchased or is considering purchasing the product(s).

When the homepage that introduces one or more products or services (hereinafter referred to as a “homepage for product introductions”) is inaccessible due to any reason, or when any failure occurs related to the homepage for product introductions due to any reason, the number of users who make inquiries about the failure related to the homepage for product introductions increases (hereinafter the failure related to the homepage for product introductions is simply referred to as a failure). Namely, the number of questions related to the homepage for product introductions increases.

To deal with this, the setting information may include a message that is used as a response when a failure has occurred, for example. In addition, the setting information may include criteria used to determine whether a failure occurs or not. Such the setting information allows the response unit 1003 to respond, based on the external environment information, according to a network status or the like.

In addition, the scenario may be grouped according to the changes. Specifically, groups, such as “for disaster case” and “for normal case” may be set in advance. Then, each of the scenario, the FAQ (FAQ list), the database, and the like may be divided in groups (grouped), and the groups may change, or modifies, based on the setting information, for example.

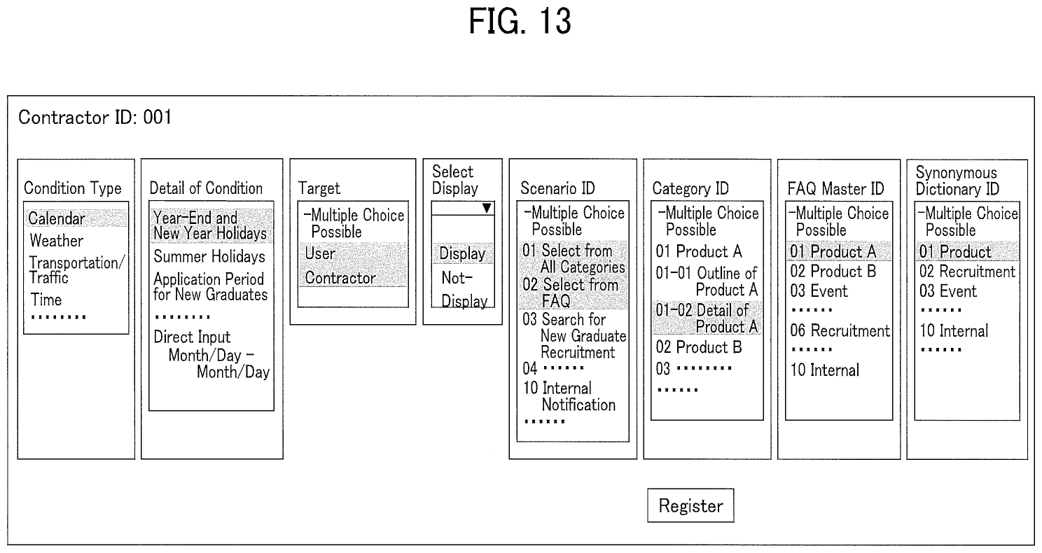

FIG. 13 is a diagram illustrating an example of a registration screen according to one or more embodiments of the disclosure. When a registration operation is performed on the screen as illustrated in FIG. 13, a registration information table, Table 1, which is described below, is registered. In FIG. 13, items in gray are being selected.

For example, when each item is selected one by one as illustrated in FIG. 13, and a “Register” button is pressed, the registration information for one line illustrated in the following table, which is Table 1, is set.

TABLE 1
CONTRACTOR ID = 001

| | | | DISPLAY | | | | |
|---|---|---|---|---|---|---|---|
| CONDITION | | | OR NOT- | SCENARIO | CATEGORY | FAQ | SYNON- |
| TYPE | DETAIL OF CONDITION | TARGET | DISPLAY | ID | ID | MASTER ID | YMOUS ID |
| CALENDAR | YEAR-END AND NEW | USER | DISPLAY | 01, 02 | 01-02 | 01, | 01, |
| | YEAR HOLIDAYS | CONTRACTOR | | | PRODUCT A | PRODUCT | PRODUCT |
| | (12/1-1/31) | | | | DETAIL | | |
| | | | | | INFORMATION | | |
| CALENDAR | SUMMER HOLIDAYS | USER | DISPLAY | 01, 02 | 02-02 | 01, | 01, |
| | (8/1-8/15) | CONTRACTOR | | | PRODUCT B | PRODUCT | PRODUCT |
| | | | | | DETAIL | | |
| | | | | | INFORMATION | | |
| CALENDAR | APPLICATION PERIOD | USER | DISPLAY | 01, 02, 03 | 06. | 02, | 02, |
| | FOR NEW GRADUATES | CONTRACTOR | | | RECRUITMENT | RECRUITMENT | RECRUITMENT |
| | (3/1-5/31) | | | | FOR NEW | | |
| | | | | | GRADUATES | | |
| EVENT | MUSIC | USER | DISPLAY | 01, 02 | 03-01 | 03, | 03, |
| | ENTERTAINMENT | | | | MUSIC EVENT | EVENT | EVENT |
| WEATHER | TYPHOON | CONTRACTOR | DISPLAY | 01, 02, 10 | 10-1 | 10, | 10, |
| | | | | | COMMUTE | INTERNAL | INTERNAL |
| CALENDAR | NEW YEAR HOLIDAYS | USER | NOT- | — | — | — | — |
| | | CONTRACTOR | DISPLAY | | | | |

A selection operation with respect to “Condition Type” is performed on the registration screen. For example, “Calendar” is to be selected for a registration for performing a change of the response based on dates registered in the “Detail of Conditions”. Accordingly, in “Condition Type” of “Calendar”, a current date, time, season, etc. are acquired as the external environment information.

“Target” is an item for setting what kind of information is used. Specifically, when “User” is selected, the location information and the external environment information of the user terminal 2 are acquired, for example. When “Contractor” is selected, the location information of the server 1, the registration information of the contractor, and the external environment information are acquired, for example. As described above, the change unit 1005 changes (make a change in) the search, the response, or the like.

For example, it is assumed that the user inputs a question and “December 20” using the user terminal 2. First, the change unit 1005 determines whether “December 20” is included in a period registered in the “DETAIL OF CONDITIONS” in the above-described table (Table 1). Because “December 20” is included in the “Detail of Conditions” of “YEAR-END AND NEW YEAR HOLIDAYS” in the first line, the change unit 1005 specifies the registration information of the first line in the above-described table (Table 1).

In addition, the change unit 1005 determines for each condition type registered in the registration information table as illustrated in the above-described table (Table 1). Specifically, when the information is registered as illustrated in the above-described table (Table 1), the change unit 1005 checks information related to a date on which a question is asked and determines whether there is another type of information related to. That is, in this example, the change unit 1005 determines whether a music/entertainment event is held around the surrounding area of the position of the user based on the position information of the user terminal 2, which is acquired by the terminal information acquisition unit 1007. Similarly, in this example, the change unit 1005 also determines whether current weather of the location of the server 1 acquired by the contractor information acquisition unit 1006 is typhoon or whether current weather of the location registered in “Contractor” is a typhoon. That is, the change unit 1005 determines whether the detail of condition is satisfied for each condition type. Then, when determining that the detail of condition is satisfied, the change unit 1005 specifies the registration information. Accordingly, a plurality of registration information may be specified depending on the input question and the registration information.

In step S903, the change unit 1005 determines whether to display or hide the bot. Then, when determining to display the bot (YES in step S903), the change unit 1005 performs step S904. On the other hand, when determining not to display the bot (NO in step S903), the change unit 1005 performs step S906.

In step S904, the change unit 1005 changes the search or the response. Specifically, the DB or the like is changed based on the setting information. For example, the change unit 1005 changes the DB in a manner that the DB is set in “SCENARIO ID”, “CATEGORY ID”, “FAQ MASTER ID”, OR “SYNONYMOUS ID” illustrated in the above-described table (Table 1), for performing the search or the response. Specifically, when the first line in the above-described table (Table 1) is applicable, the scenario IDs “01” and “02” are used. Further, when the first line in the above-described table (Table 1) is applicable, the categories each of which has one of the category IDs of “01” and “02” are used. Further, when the first line in the above-described table (Table 1) is applicable, a FAQ master having the FAQ master ID of “01” is used. Further, when the first line in the above-described table (Table 1) is applicable, a dictionary of synonymous (synonymous dictionary) having the Synonymous ID of “01” is used. As described above, each DB is associated with a condition in advance and the DB to be searched changes depending on the condition. The subsequent processing for the search or the response is performed based on the settings changed in step S904.

In step S905, the control unit of the server 1 determines to respond to a content request of the bot. The subsequent processing for responding, displaying, and the like is performed based on the settings set in step S904.

In step S906, the control unit of the server 1 determines not to respond to a content request of the bot. After that, processing such as the response is not performed, and for example, the server 1 waits until receiving a next request for starting the bot.

Step S109 is performed as described above, for example.

In step S110, the communication unit of the server 1 transmits to the user terminal 2 content information or the like for conducting a dialog with the bot. When not to respond is determined in step S109 (that is, the processing of step S906 is performed), the content information is not transmitted, and the subsequent processing is canceled.

In step S111, the output unit 2002 of the user terminal 2 displays the content or the like for the dialog conducted with the bot.

An icon for starting the chatbot service may be set to be displayed in advance by the administrator. In such a case (“CASE OF DISPLAYING ICON” in FIG. 11), the process of the chatbot system 100 proceeds to step S112. On the other hand, when such an icon is not set to be displayed, the process of the chatbot system 100 proceeds to step S114.

In step S112, the user performs an operation of pressing, for example, the icon for starting the chatbot service. Thereby, the input unit 2001 of the user terminal 2 receives the operation of pressing the icon.

In step S113, the output unit 2002 of the user terminal 2 starts a dialog (conversation) with the chatbot based on a scenario or the like. In the following description of an example case, the user selects a scenario, and a dialog is started.

In step S114, the user performs an operation of selecting a scenario. Specifically, as illustrated in the above-described table (Table 1), a plurality of scenario IDs may be set. In such a case, the output unit 2002 of the user terminal 2 displays a GUI that allows the user to select one of the plurality of scenarios.

In step S115, the input unit 2001 of the user terminal 2 receives the operation of selecting a scenario performed in step S114. Then, the communication unit of the user terminal 2 transmits a notification indicating the selected scenario to the server 1.

In step S116, the control unit of the server 1 specifies content to be displayed in the dialog in the scenario specified by the setting information.

For example, when an option of “SELECT FROM ALL CATEGORIES” is selected in step S31, the content is specified such that “CATEGORY NAME” of the category, which is set in the “CATEGORY ID” in the setting information switched in step S109, is used as a response.

In addition, when an option of “SELECT FROM FREQUENTLY ASKED QUESTIONS” is selected in step S31, first, for example, the top five questions are extracted based on the inquiry history information generated within a predetermined period.

In addition, for example, it is assumed that a scenario such as “Checking Extension Phone” is selected in step S114. In such a case, content as a response is specified such as a message, “Please enter a name.”, which is set in advance.

In step S117, the communication unit of the server 1 transmits the content to be displayed.

In step S118, the output unit 2002 of the user terminal 2 displays the content transmitted in step S117. It is assumed that the processing related to a question, a search, and a response is performed according to the scenario determined in step S109, for example, as illustrated in FIG. 5.

In step S119, the user inputs a question. Therefore, in step S119, the input unit 2001 of the user terminal 2 receives the user input. Then, input information indicating the received question is generated.

In step S120, the input information acquisition unit 1001 acquires the input information from the user terminal 2.

In step S121, the search unit 1002 searches for response information associated with the input information using a category, a FAQ master, a dictionary of synonymous, or the like specified in the setting information.

In step S122, the response unit 1003 responds with the response information. The response unit 1003 may respond with a response message obtained or generated by performing predetermined processing on the response information. That is, the response message generated based on the response information may be used to answer to the question.

In step S123, the output unit 2002 of the user terminal 2 displays an answer to the question based on the response information.

The processing of steps S119 to S123 may be performed repeatedly. The processing of steps S124 to S128 may be performed after the answer is provided as a response, that is, after step S123 is performed.

In step S124, the output unit 2002 of the user terminal 2 displays one or more input items for investigating a user satisfaction (feedback). That is, the output unit 2002 of the user terminal 2 displays one or more questionnaires for investigating the user satisfaction with respect to the answer obtained in step S123, and the output unit 2002 of the user terminal 2 also displays a GUI that allows the user to input a satisfaction level, namely feedback.

In step S125, the user inputs the satisfaction level, namely the feedback.

In step S126, the communication unit of the user terminal 2 notifies the server 1 of the content input in step S125 (input content), that is, a result obtained from the one or more questionnaires, for example.

In step S127, the storage unit of the server 1 stores the content notified in step S126 or the content of the dialog as a history.

The server 1 may perform statistical processing related to the user satisfaction based on the content of the satisfaction level (feedback). Specifically, the server 1 displays, for the administrator, for example, a graph indicating the level of user satisfaction (for example, the user is prompted to input a degree, or a level, selected from a group of “satisfied”, “dissatisfied”, “neither satisfied nor dissatisfied” or “no answer”, in step S125) in relation to dialogs conducted with the chatbot in a predetermined period. Such a result of the statistical processing in relation to the user satisfaction provided as feedback allows the administrator to objectively learn the degree of the user satisfaction.

In step S128, the process performed by the control unit of the user terminal 2 returns to, for example, step S112 or step S114. That is, the control unit of the user terminal 2 displays a top screen, or an initial screen, of the chatbot, again. Alternatively, in step S128, the chatbot system may end the chatbot.

As described above, the change unit 1005 changes the search or the response based on the external environment information. Because of the change as described above, the response suitable for the external environment is achievable. This allows the user to easily obtain information suitable for the external environment of the user, resulting in improving the convenience. In addition, when the change unit 1005 makes a change based on the external environment information, the operation for the change is performed automatically, which results in reducing man-hours of the administrator or the like and improving the convenience for management. In addition, when the change unit 1005 makes a change based on the external environment information, the change is reflected quickly, which results in implementing real-time processing.

As described above, the convenience in using the bot is improved.

### Second Embodiment

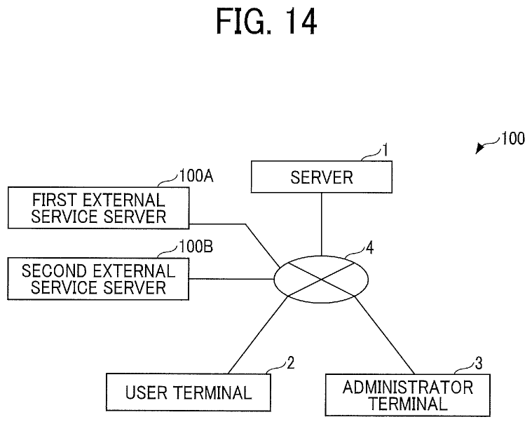

FIG. 14 is a diagram illustrating an example of an overall configuration of a chatbot system (information processing system) according to a second embodiment of the disclosure. Compared with the first embodiment, the second embodiment is different in that a first external service server 100A and a second external service server 100B are connected via the communication network 4.

In the following description, a service provided by the first external service server 100A is referred to as a “service A”, and a service provided by the second external service server 100B is referred to as a “service B”.

In step S901 illustrated in FIG. 12, the server 1 acquires external environment information by using one or more external services such as the “service A” or the “service B” through the network.

For example, the external environment information acquisition unit 1004 acquire external environment information related to holidays from an external service, which provides a calendar service, external environment information related to a meteorological disaster from an external service, which provides a weather service, or external environment information related to traffic congestion from an external service, which provides traffic information. Then, the change unit 1005 acquires setting information based on the acquired external environment information.

In addition, condition types that are selectable in the item of “condition type” on the registration screen illustrated in FIG. 13 is switchable depending on the external service being connected. For example, when the calendar service and the weather service are connected, other conditions provided by other services than the calendar service and the weather service are not settable. As described above, the chatbot system 100 may be configured to connected to a server that provides an external service.

Variations

In the information processing system, the steps of the process in the method of processing information described above may be performed in parallel, distributed or redundant to be performed by a plurality of information processing devices. The information processing system may apply a so-called cloud computing.

The number of each device or apparatus described above is not limited to one. That is, each device or apparatus described above may be a combination of a plurality of devices. The information processing system may be configured to further include devices other than the devices described above.

In addition, the information processing system or the information processing device may use Artificial Intelligence (AI) or the like. For example, the information processing system or the information processing device may be configured to improve recognition accuracy by performing machine learning in character input or the like.

All or a part of each process according to some embodiments of the present disclosure may be described in a computer language and may be implemented by a program for causing a computer to execute a method of processing information (information processing method). That is, the program is a computer program for causing a computer such as an information processing device or an information processing system to execute an information processing method.

When such an information processing method is executed based on such a program, the arithmetic device and the control device included in the computer perform the calculation and control based on the program in order to execute each process. The storage device of the computer stores data used for processing based on the program in order to execute each processing.

Further, the program may be recorded on a computer-readable recording medium and distributed. Note that the recording medium may be a medium such as a magnetic tape, a flash memory, an optical disk, a magneto-optical disk, or a magnetic disk. Further, each program may be distributed through a telecommunication line.

As described above, an example in the embodiment has been described, but the present disclosure is not limited to the embodiment. That is, various modifications and improvements can be made within the scope of the present disclosure.

In conventional methods, search or respond does not change according to change in external environment. In such a method, a response suitable for the external environment is not provided unless, for example, an administrator changes settings, which results in low convenience.

In view of the above-described problem, an object of one or more embodiments of the present disclosure is to improve convenience in using a bot.

An effect of one or more embodiments of the present disclosure is to improve convenience in using a bot.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. An information processing device, comprising circuitry configured to
acquire, from a user terminal, input information corresponding to a user input received at the user terminal,
search for response information associated with the input information,
respond to the user terminal with a response message generated based on the response information associated with the input information, and
acquire external environment information related to at least one of the user terminal or the information processing device, and
wherein, the circuitry changes, according to the external environment information, at least one of search or response.

2. The information processing device according to claim 1,
wherein the external environment information includes information related to at least one of a location of the user terminal or a surrounding area of the user terminal, the information including at least one of time information, weather information, season information, traffic information, network status information, or position information.

3. The information processing device according to claim 1,
wherein, the circuitry changes, at least one of a scenario, a frequently asked question (FAQ) list, or a database to change the search according to the external environment information.

4. The information processing device according to claim 1,
wherein the circuitry changes, according to the response information, at least one of content to be displayed on the user terminal or a display order of the user terminal to change the response according to the external environment information.

5. An information processing system, comprising:
one or more information processing devices according to claim 1; and
a user terminal configured to receive the user input.

6. The information processing system according to claim 5,
wherein the external environment information includes information related to at least one of a location of the user terminal or a surrounding area of the user terminal, the information including at least one of time information, weather information, season information, traffic information, network status information, or position information.

7. The information processing system according to claim 5,
wherein, the circuitry changes, at least one of a scenario, a frequently asked question (FAQ) list, or a database to change the search according to the external environment information.

8. The information processing system according to claim 5,
wherein the circuitry changes, according to the response information, at least one of content to be displayed on the user terminal or a display order of the user terminal to change the response according to the external environment information.

9. A method of processing information, comprising:
acquiring input information from a user terminal, the input information being corresponding to a user input received by the user terminal;
searching for response information associated with the input information;
responding to the user terminal with a response message generated based on the response information associated with the input information;
acquiring external environment information related to at least one of the user terminal or an information processing device; and,
changing, according to the external environment information, at least one of search or response.

10. The method of processing information according to claim 9,
wherein the external environment information includes information related to at least one of a location of the user terminal or a surrounding area of the user terminal, the information including at least one of time information, weather information, season information, traffic information, network status information, or position information.

11. The method of processing information according to claim 9,
wherein the changing includes changing at least one of a scenario, an FAQ list, or a database to change the search according to the external environment information.

12. The method of processing information according to claim 9,
wherein the changing includes changes, according to the response information, at least one of content to be displayed on the user terminal or a display order of the user terminal to change the response according to the external environment information.

13. A non-transitory recording medium storing a plurality of instructions which, when executed by one or more processors, cause the processors to perform a method, comprising:
acquiring input information from a user terminal, the input information being corresponding to a user input received by the user terminal;
searching for response information associated with the input information;
responding to the user terminal with a response message generated based on the response information associated with the input information;
acquiring external environment information related to at least one of the user terminal or an information processing device; and,
changing, according to the external environment information, at least one of search or response.
